(19) United States
(12) Patent Application Publication
(10) Pub. No.: US 2020/0046589 A1
(43) Pub. Date: Feb. 13, 2020

(54) DISPOSABLE PROTECTIVE CELLULAR TELEPHONE BAG AND DISPENSER FOR USE IN HOSPITAL ROOMS, ETC. AND METHODS OF USE

(71) Applicant: Boehringer Technologies, LP, Phoenixville, PA (US)

(72) Inventor: Samantha Ashley Simmons, West Chester, PA (US)

(21) Appl. No.: 16/532,890

(22) Filed: Aug. 6, 2019

Related U.S. Application Data
(60) Provisional application No. 62/716,117, filed on Aug. 8, 2018.

(51) Int. Cl. A61G 10/00; A45C 13/00; B65D 33/04; B65D 33/16; B65D 81/18

(52) U.S. Cl. CPC A61G 10/005; A45C 13/002; A45C 2011/002; B65D 33/1691; B65D 81/18; B65D 33/04

(57) ABSTRACT

A system including a plurality of disposable bags, a dispenser for the bags and a method of use for accommodating a personal electronic device within each bag to isolate it from the ambient atmosphere is disclosed. Each of the bags includes a pair of panels of a flexible transparent material forming a hollow cavity or pocket having an open mouth through which the personal electronic device may be inserted. Each bag includes a flap for adhesively sealing the mouth of the bag with the device therein so that any pathogens on the device are sealed and isolated within the bag, and pathogens in the ambient atmosphere will not come in direct contact with the personal electronic device. The panels of the bag are frangible so that the bag can be torn open to remove the device, when desired. The dispenser is configured to dispense the bags one at a time.

### CROSS-REFERENCE TO RELATED APPLICATIONS

This utility application claims the benefit under 35 U.S.C. § 119(e) of Provisional Application Ser. No. 62/716,117 filed on Aug. 8, 2018, entitled Disposable Protective Cellular Telephone Bag for Use in Hospital Rooms, Etc. and Methods of Use. The entire disclosure of the provisional application is incorporated by reference herein.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISK

Not Applicable

### FIELD OF THE INVENTION

The disclosed invention relates to flexible bags and more particularly to flexible bags for receipt of cellular telephones or other electronic devices so that they may be brought into patient rooms in hospitals and laboratories to minimize the chance that any pathogen on the device will contaminate the room or the patient or that pathogens will not land directly on the device and be transferred out of the room or facility.

### BACKGROUND OF THE INVENTION

Infection control in hospitals is a major and growing concern. Thus, efforts are being made to keep patient rooms as sanitary and clean as possible. To that end, it is common practice to have hand cleaners in or outside patient rooms so that visitors can sanitize their hands to prevent or minimize the chances that they will bring some pathogen into or out of the patient's room.

A recent study has shown that cellular telephones are a serious source of bacterial contamination. In particular, it was determined that a vast majority of typical cellphones had significant bacterial contamination, including one or more of the pathogens, Staphylococcus epidermidis, Bacillus spp., Staphylococcus aureus, Pseudomonas Aeruginosa, Escherichia coli, Streptococcus spp., Proteus spp., Klebsiella spp. and Acinetobacter spp. Thus, visitors to hospital rooms who bring their cellular telephones with them risk contaminating that room with any of the pathogens on their cellular telephones, particularly, if the patient uses that cellular telephone.

United States Published Patent Application 2014/0260091 (Sacks) discloses an enclosure, e.g., a plastic bag, made of a flexible sheet material configured for receipt of a cellular telephone, a tablet, computer, etc., so that it can be brought into a hospital room with minimal risk of contaminating that room.

While the enclosure of that published application may be suitable for its intended purposes it nevertheless leaves much to be desired from one or more of the standpoints of simplicity of construction, ease of use, effectiveness and inability to be reused after the device has been removed from the enclosure since such reuse could present a contamination hazard if the enclosure was not sterilized before reuse.

Accordingly, a need exists for a very low cost disposable enclosure for a cellular telephone, tablet computer, laptop computer or other electronic device, which is low in cost, simple in construction, easy to use, and very effective for isolating any pathogens on the device from the ambient surroundings, all the while enabling the device to be used in the patient's room, and to be readily removed from the enclosure after leaving the patient's room. The subject invention addresses that need. Moreover, while the subject invention has particular utility for use in hospital rooms, it has various other infection control uses as well. For example, it can be used in a residential setting, a nursing home, or any other facility where a sick person or a person with a compromised immune system is located or can be used in scientific laboratories and veterinary clinics.

All of the references as cited herein are specifically incorporated by reference.

### SUMMARY OF THE INVENTION

One aspect of this invention is a disposable bag for accommodating and isolating a cellular telephone, tablet computer or laptop computer from the ambient atmosphere so that any pathogens thereon are sealed and isolated within the bag and additional pathogens do not contaminate the phone. The bag comprises a first panel, a second panel, a first securement region, a second securement region, a first weakened frangible line, a second weakened frangible line, an adhesive and a removable liner. The first panel is formed of a flexible material and has a first end edge portion. The second panel is formed of a flexible material and has a second end edge portion. The flexible material of at least one of the panels is configured to enable the operation of a touch screen of the cellular telephone, tablet computer, laptop computer or other personal electronic device through the panel. The first and second panels are secured together along portions thereof other than the first and second end edge portions to form an internal pocket or cavity having a mouth defined by the first and second end edge portions. The mouth is open to enable the cellular telephone, tablet computer or laptop computer to be introduced therethrough into the internal cavity. The second end edge portion extends beyond the first edge portion to form a flap. The first securement region is on the first panel located adjacent the first end edge portion. The second securement region is on the second panel located adjacent the second end edge portion. The first weakened frangible line extends along at least a portion of the first panel. The second weakened frangible line extends along at least a portion of the second panel coincident with the first weakened frangible line. The adhesive is located on one of the securement regions. The removable liner is releasably secured to the adhesive and is configured to be removed from the adhesive to expose the adhesive. The flap is configured to be folded over the first securement region after the removable liner has been removed from the adhesive, whereupon the adhesive fixedly secures the second securement region to the first securement region, thereby closing the mouth and sealing the cellular telephone, tablet computer or laptop computer within the internal cavity.

In accordance with one preferred aspect of the bag of this invention, the first and second panels each include a side edge and with the first and second panels being fixedly secured together along the side edge. The first and second weakened frangible lines extend from the side edge.

In accordance with another preferred aspect of the bag of this invention, the side edge of each of the first and second panels at the location of the weakened frangible lines includes a notch cut therein, so that the bag can be grasped and torn along the weakened frangible lines starting at the notch.

In accordance with another preferred aspect of the bag of this invention, the flexible material of at least one of the panels is transparent.

In accordance with another preferred aspect of the bag of this invention, the flexible material of the first and second panels comprises polypropylene or low density polyethylene.

In accordance with another preferred aspect of the bag of this invention, the flexible material of the first and second panels is sufficiently thin to enable one to use the full functionality of the cellular telephone, tablet computer, or laptop computer while the cellular telephone, tablet computer, or laptop computer is within the internal cavity.

In accordance with another preferred aspect of the bag of this invention, at least one of the panels is configured to change appearance after a certain amount of time to indicate that the bag should be discarded.

In accordance with another preferred aspect of the bag of this invention, at least one of the panels includes an antimicrobial agent.

Another aspect of this invention is a system for dispensing disposable bags, each of the bags being configured for accommodating and isolating a cellular telephone, tablet computer or laptop computer from the ambient atmosphere so that any pathogens thereon are sealed and isolated within the bag. The system comprises a dispenser and a plurality of disposable bags. The dispenser comprises a housing configured for receipt of a plurality of the disposable bags, with the housing being configured to enable the dispensing of the disposable bags one at a time. Each of the disposable bags is constructed similarly to that described above.

In accordance with one preferred aspect of the system of this invention the plurality of bags is in the form of a stack of bags, having an uppermost bag. The dispenser includes a door moveable between an open position and a closed position, and vice versa. When the door is in the closed position it is configured to releasably grasp a portion of the uppermost bag. When the door is moved to the open position the bag is opened to enable the cellular telephone, tablet computer, laptop computer, or other personal electronic device to be inserted therein.

In accordance with another preferred aspect of the system of this invention, the door includes an adhesive surface configured to releasably grasp the portion of the uppermost bag.

In accordance with another preferred aspect of the system of this invention, the system additionally comprises a biasing member to ensure that the adhesive surface releasably grasps the portion of the uppermost bag irrespective of the number of bags in the stack.

Another aspect of this invention is a method of protecting a person from pathogens that may be located on a cellular telephone, tablet computer, laptop computer or other electronic device. The method comprises providing a disposable bag having a first panel formed of a flexible material having a first end edge portion, a second panel formed of a flexible material and having a second end edge portion. The flexible material of at least one of the panels being configured to enable the operation of a touch screen of the cellular telephone, tablet computer, laptop computer, or other personal electronic device through the panel. The first and second panels are secured together along portions thereof other than the first and second end edge portions to form an internal cavity having a mouth defined by the first and second end edge portions. The second end edge portion extends beyond the first edge portion to form a flap. At least one of the panels includes a weakened frangible line. The first panel has a first securement region located adjacent the first end edge portion. The second panel has a second securement region located on the flap adjacent the second end portion. An adhesive is located on one of the securement regions. A removable liner is releasably secured to the adhesive. The cellular telephone, tablet computer, laptop computer or other electronic device is introduced through the mouth into the internal cavity. The liner is removed from the adhesive to expose the adhesive. The flap is folded over the first panel to fixedly secure the first securement region to the second securement region by the adhesive to thereby isolate the cellular telephone, tablet computer, laptop computer or other electronic device within the cavity, whereupon the cellular telephone, tablet computer, laptop computer or other electronic device can be operated while within the bag and without exposing the person to any pathogens on the cellular telephone, tablet computer, laptop computer or other electronic device.

In accordance with one preferred aspect of the method of this invention, the method additionally comprises tearing the bag along the weakened frangible line to open the bag, whereupon the cellular telephone, tablet computer, laptop computer or other electronic device can be removed therefrom and the bag discarded.

In accordance with another preferred aspect of the method of this invention, the disposable bag is located within a dispenser located adjacent or in a room where the person is located, and wherein the dispenser comprises a housing is configured to hold a plurality of the bags in a sanitary state to enable an individual bag to be removed from the dispenser for use.

### BRIEF DESCRIPTION OF THE DRAWING FIGURES

FIG. 1 is a front view of one exemplary embodiment of a disposable bag constructed in accordance with this invention and showing a typical cellular telephone located and sealed within the bag so that it and any pathogens located on it are isolated from the ambient surroundings, whereupon the bag with the cellphone can be safely brought into and used in a patient's room without risk of contaminating that room or the patient.

FIG. 2 is a front view of the embodiment of the disposable bag shown in FIG. 1, but before the cellular telephone is introduced and sealed therein;

FIG. 3 is an enlarged sectional view taken along line 3-3 of FIG. 2;

FIG. 4 is a reduced isometric view showing a sanitary dispenser for storing a plurality of the disposable bags of this invention, which dispenser may be mounted on a wall just outside a patient's room, or within the patient's room or at any other location deemed appropriate;

FIG. 5 is an enlarged exploded isometric view of a more preferred sanitary dispenser storing the stack of disposable bags constructed in accordance with this invention;

FIG. 6 is a reduced front elevation view of the sanitary dispenser shown in FIG. 5;

FIG. 7 is a slightly enlarged side elevation view of the sanitary dispenser shown in FIG. 6, wherein the dispenser includes a door that when opened, e.g., pivoted down, automatically opens the uppermost bag of the stack of disposable bags to enable a personal electronic device to be inserted therein;

FIG. 8 is an enlarged isometric view taken from a front oblique angle of the sanitary dispenser shown in FIG. 7 during the process of inserting the personal electronic device therein like shown in FIG. 7;

FIG. 9 is an isometric view taken from a side oblique angle of the sanitary dispenser shown in FIG. 8 shown after the dispenser has been used to receive a personal device in a bag in the dispenser, and the bag with the device therein removed from the dispenser, so that the dispenser can be readied for subsequent use; and

FIG. 10 is an enlarged front elevation view of an adhesive pad which is configured to be mounted on the inside of the door of the sanitary dispenser shown in FIGS. 5-9 so that when mounted therein it will automatically stick to and open the uppermost bag in the stack of bags in the dispenser when the door is opened.

### DETAILED DESCRIPTION OF THE PREFERRED EMBODIMENTS

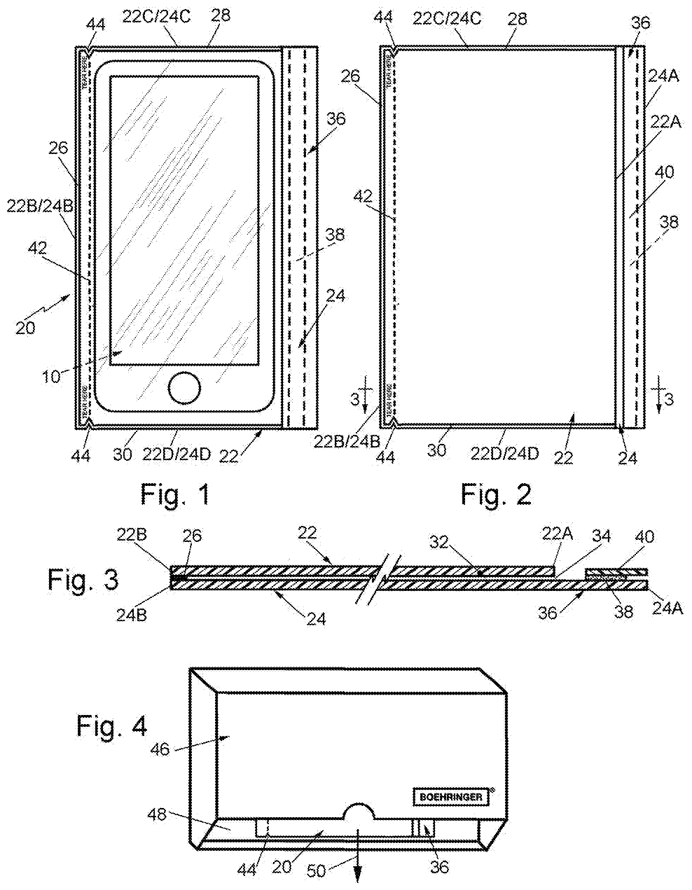

Referring now to the drawings wherein like characters refer to like parts there is shown at 20 in FIG. 1 one exemplary embodiment of a disposable bag constructed in accordance with this invention. The bag 20 can be sized and shaped to accommodate any personal electronic device, be it a cellular telephone, tablet computer, laptop computer, pager, etc. In the exemplary embodiment that is shown in the drawing and described hereinafter, the bag 20 is sized and shaped for a holding a typical cellular telephone 10 in it.

The bag basically comprises a first panel 22 formed of a flexible sheet material, e.g., polypropylene or preferably low density polyethylene, and a second panel 24, also formed of a flexible sheet material, e.g., polypropylene or preferably low density polyethylene. The panel 22 serves as the top panel or front of the bag 20 and is disposed over the panel 24, which serves as the bottom panel or rear of the bag. The panels 22 and 24 are of generally rectangular shape, with the bottom panel being slightly larger, as will be described shortly. The top panel 22 includes an end edge 22A, another end edge 22B disposed opposite the end edge 22A, and a pair of side edges 22C and 22D located between the end edges 22A and 22B. Each of the edges 22A-22D is linear. The bottom panel 24 includes an end edge 24A, another end edge 24B disposed opposite the end edge 24A, and a pair of side edges 24C and 24D located between the end edges 24A and 24B. Each of the edges 24A-24D is linear. The panel 22 is somewhat smaller in size than the panel 24. In particular its side edges 22C and 22D are shorter in length than the side edges 24C and 24D.

As best seen in FIGS. 2 and 3, the top panel 22 is disposed over the bottom panel 24, so that the end edges 22B and 24B are coincident and are permanently secured or sealed together along their entire length by a seal line 26. That securement may be achieved by heat sealing, welding or an adhesive. The side edges 22C and 24C are also coincident and are similarly permanently secured or sealed together along the length of the side edge 22C by a seal line 28, leaving a portion of the side edge 24C from the end edge 22A outward unsealed. So too, the side edges 22D and 24D are also coincident and are permanently secured or sealed together along the length of the side edge 22D by a seal line 30, leaving a portion of the side edge 24D from the end edge 22A outward unsealed.

As best seen in FIG. 3, the space between the panels 22 and 24 which is bounded by the seal lines 26, 28 and 30 is in the form of a hollow pocket or cavity 32. The pocket or cavity 32 is configured for receipt of the cellular telephone 10 or other personal electronic device. The end edge 22A and the contiguous portion of the panel 24, which is located directly under the end edge 22A, together form an open mouth or entryway 34 to the pocket or cavity 32. It is through the open mouth that the cellular telephone 10 may be inserted into the pocket or cavity.

The portion of the bottom panel 24 that extends beyond the end edge 22A of the top panel 22 forms a flap 36. The flap 36 is configured to be folded over and sealed to the outer surface of the top panel 22 contiguous with the end edge 22A to enclose and seal the cellular telephone 10 or other personal electronic device within the pocket or cavity when desired. To that end, the inner surface of the flap 36 adjacent the end edge 24A serves as a securement region that includes a strip of adhesive 38 extending the width of the panel 24 from the side edge 24C to the side edge 24D. A strip 40 of a releasably securable liner material is disposed over the strip 38 of adhesive to serve as a releasable cover for the adhesive to protect the adhesive until it is to be used to seal the flap onto the top panel. The liner strip 40 is greater in length than the length of the adhesive strip 38 so that a portion of the liner strip overhangs the portion of the bottom panel contiguous with the end edge 24A to form a grasping region of the liner strip. When it is desired to remove the liner strip to expose the adhesive to secure the flap 36 onto the outer surface of the top panel 22, all that is required is for the user to grasp the grasping portion of the liner strip 40 which overhangs the end edge 24A to pull or peel the liner strip off of the adhesive strip. The flap with the exposed adhesive strip can then be folded over the top panel 22 contiguous with the end edge 22A so that the adhesive may engage a securement region on the outer surface of the top panel 22 contiguous with the end edge 22A. That action fixedly secures the flap 36 of the bottom panel 24 to the top panel 22, thereby sealing the cellular telephone within the pocket or cavity 34, so that any pathogens on the cellular telephone are safely enclosed and isolated within the bag.

It should be pointed out at this juncture that while the adhesive strip 38 and its liner strip 40 are shown located on the inner surface of the flap adjacent the end edge 24A, it is contemplated that the adhesive strip and its liner strip may be located on the securement region of the top panel, i.e., the outer surface of the top panel 22 adjacent or contiguous with the end edge 22A. In such a case the inner surface of the flap contiguous with its end edge 24A forms the securement region to which the adhesive will be secured when the flap 36 is folded over the top panel. Thus, the adhesive strip and its associated liner strip can be located on either the securement region of the flap or the securement region of the top panel. In either case, when the flap is folded over the top panel the adhesive will fixedly secure the two securement regions to each other and seal the mouth 34 of the bag.

In accordance with one preferred aspect of this invention the material making up at least one of the panels 22 and 24 is sufficiently flexible and/or thin and has appropriate electrical properties to enable the user to operate the cellular telephone's touch screen, be it resistive or capacitive, through the panel to ensure that the functionality of the cellular telephone 10 is not compromised when it is sealed within the bag. Moreover, the material making up the panels 22 and 24 is preferably transparent so that the user can see the screen of the cellular telephone and any button through the panels. While it is preferred that both panels be so constructed, it is contemplated that at least one of the panels 22 and 24 be constructed to provide full functionality for the electronic device's touch screen when that device is within the bag 20.

In accordance with another preferred aspect of this invention the panels of the bag include weakened or frangible portions which are configured to be torn to remove the cellular telephone 10 from the bag 20 when isolation of the cellular telephone is no longer necessary, e.g., the cellular telephone is out of the patient's room. In particular, as can be seen in FIGS. 1 and 2, the top panel 22 and bottom panel 24 each include a weakened or frangible line 42 extending between the side edges 22C/24C and 22D/24D. The frangible lines 42 may be formed in various ways, e.g., may be perforated, and are preferably linear, but can be of any shape. Moreover, it is preferred that the frangible lines be coincident. Further still, while the frangible lines 42 are shown as extending the full width of the bag between the side edges of the bag, it is contemplated that the coincident frangible lines extend only a portion of the width of the bag from one of the side edges, e.g., side edges 22C/24C or side edges 22D/24D. In any case, it is preferable, but not mandatory, that the portion of the side edges from which the frangible lines 42 extend include a notch 44 to serve as a starting point for tearing the bag along the frangible lines 42. In the exemplary embodiment two such notches 44 are shown, one at each end of the coincident frangible lines 42 and located closely adjacent coincident the end edges 22B/24B . It should be pointed out at this juncture that the bag may include printed markings, e.g., indicia bearing the words “Tear Here”, like shown in FIGS. 1 and 2, to indicate the existence of the frangible lines and that the user is to tear the bag open along those lines. The use of such indicia, while preferred is nevertheless optional.

As will be appreciated by those skilled in the art, all that is required to tear open the bag 20 to remove the cellular telephone 10 from within the pocket or cavity is for a user to grasp the bag immediately adjacent one of the notches 44 and to pull on the bag on either side of the notch to cause the notch to break or tear. That tear will cause the contiguous coincident frangible line 42 to tear with the tear propagating along the length of those frangible lines until the bag is sufficiently open to remove the cellular telephone. The torn bag can then be discarded.

FIG. 4 shows a sanitary dispenser 46 in the form of a hollow housing in which a plurality of bags 20 may be stored in a sanitary state ready for use when desired. The dispenser 46 and the plurality of bags form one exemplary system for dispensing disposable bags constructed in accordance with this invention.

The housing 46 includes an open bottom 48 from which a bag 20 may be withdrawn or pulled in the direction of arrow 50. The housing with the bags 20 therein may be located just outside a patient's room or within the patient's room, or in any other suitable location. The plurality of bags 20 held within the housing may be in the form of a stack of such bags, or in the form of a reel of serially disposed plural bags which are configured to be torn away from the reel, one bag at a time, so that the separated bag can be used to accommodate the cellular telephone within it. In lieu of the dispenser 46 Moreover, it is contemplated that the sanitary dispenser may be constructed differently than that shown in FIG. 4. In particular, an alternative sanitary dispenser for the bags of this invention may be in the form of a hollow housing which is configured to receive a disposable box containing plural bags 20, in a manner similar to conventional dispensers holding boxes of disposable gloves found in hospitals, doctor's offices, etc.

It has been found that for accommodating typical cellular telephones the bag 20 may have the following exemplary dimensions. The length of the bag, i.e., the distance between the side edges 22C/24C and 22D/24D, is 7.75 inches. The width of the bottom panel, i.e., the distance between the end edges 24B and the end edge 24A, is 6 inches. The width of the top panel, i.e., the distance between the end edge 22B and the end edge 22A, is 4.5 inches. The distance from the coincident end edges 22B/24B to the frangible line 42 is 0.5 inches. The width of the adhesive strip is 0.5 inch.

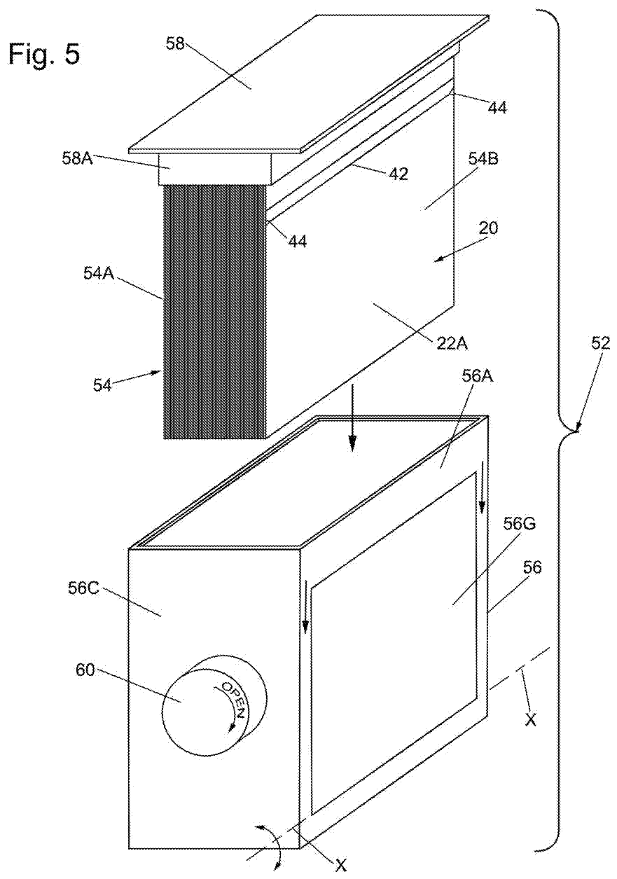

Turning now to FIGS. 5-10 there is shown a more preferred dispenser 52 for storing and holding a plurality of disposable bags constructed like that described above. The bags are preferably in the form of a stack 54, one bag on top of another bag, starting at the lowermost bag and going to the uppermost bag. The dispenser 52 and the stack of bags 54 form a more preferred system for dispensing sanitary bags for cellular telephones, tablet computers, laptop computers, or other personal electronic devices.

As will be described in detail shortly, the dispenser 52 is configured for opening one bag at a time, starting with the uppermost bag, to allow a user to introduce (e.g., drop) his or her personal electronic device, e.g., cellphone 10, into the opened bag without the user having to touch the bag to open it. Once that has been accomplished the user can then remove the bag with the personal electronic device in it from the dispenser and seal the personal electronic device within the bag.

The stack of bags 54 is shown in FIG. 5 and basically comprises a stack of identical bags 20, each of which is constructed like those described above and which are stacked one upon another starting at the lowermost bag 54A to the uppermost bag 54B and with their front panels 22 facing upward. The stack can contain any number of bags, although it is preferred that it be a relatively large number, e.g., 200, so that replacement of the stack in the dispenser 52 need not be carried out frequently.

The dispenser 52 basically comprises a housing 56 and a cover or lid 58. The housing can be of any shape. In the exemplary embodiment shown it is in the form of a parallelepiped having a front wall 56A, a rear wall 56B, a first side wall 56C, a second sidewall 56D, and a bottom wall 56E. The back wall 56B of the housing is configured to be secured onto the wall of the hospital, etc., to mount the dispenser 52 thereon.

The top of the housing is open and is configured to be closed by the cover or lid 58 to form a hollow interior 56F of the housing. The cover or lid 58 is a generally planar member whose undersurface includes a rectangular shaped socket 58A. The socket is configured to receive the top edge portions 24A of the stack of bags 54, so that when the stack is in the socket and the cover or lid mounted to close the open top of the housing the stack will be located within the interior 56F of the housing and facing the front wall 56A.

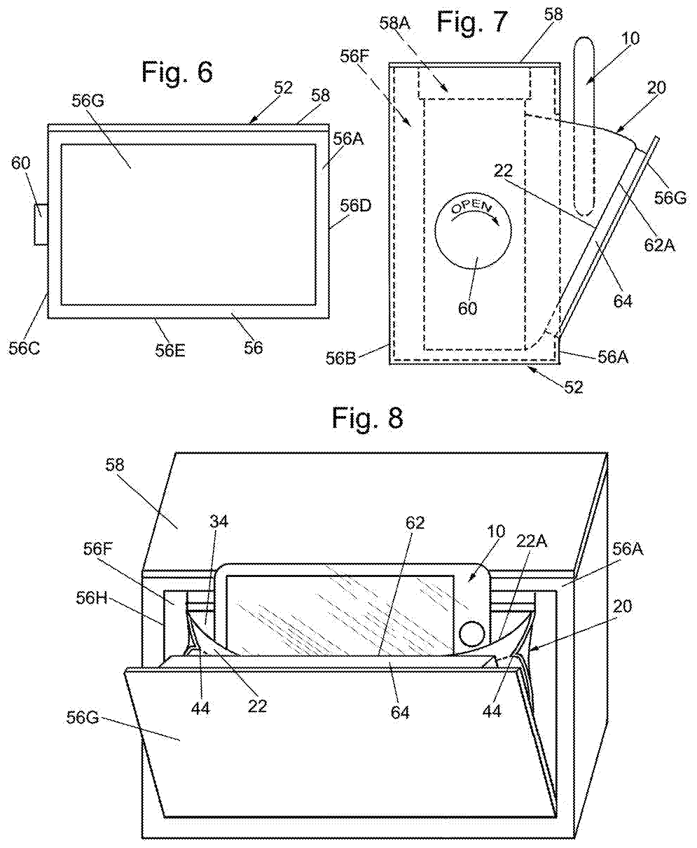

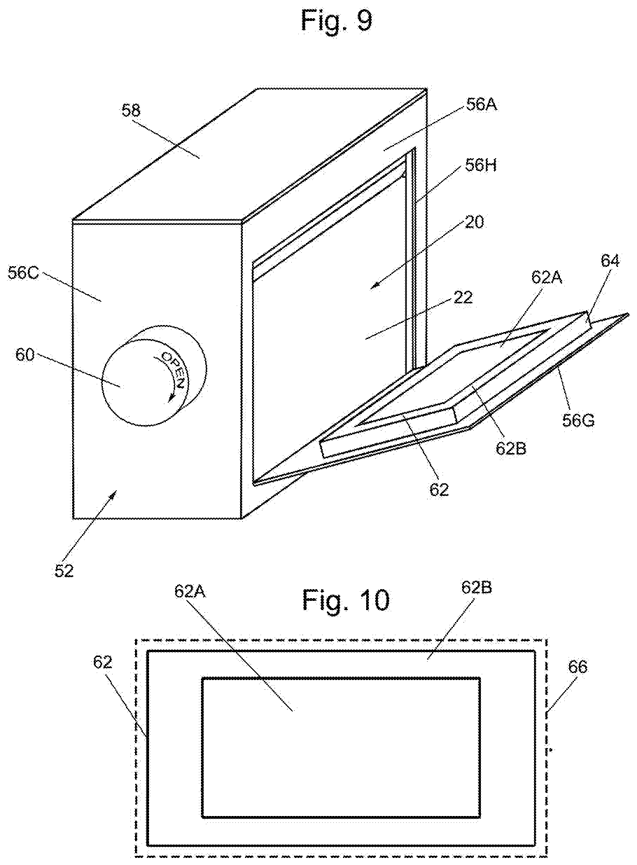

The front wall 56A includes a door 56G which is pivotably mounted in a window or opening 56H by a hinge (not shown) so that the door can be pivoted about the axis X of the hinge from a closed position like shown in FIG. 5, to a partially open position like shown in FIG. 6 or to a fully open position like shown in FIG. 9. Indicia in the form of arrows can be placed on the housing, like shown in FIG. 5, to indicate the direction that the door 56G will open.

As will be described shortly, when the door is in its closed position the stack of bags will be isolated from the ambient surroundings to keep them sanitary. When the door is pivoted to the partially open position, that action automatically opens the mouth 34 of the uppermost bag 54B so that the personal electronic device 10 can be inserted into the bag through the bag's mouth like shown in FIGS. 7 and 8. The pivoting of the door about the axis X can be accomplished in various ways. One preferred way is by means of a rotatable knob 60, which is mounted on the side wall 56C and is coupled by a linkage system (not shown) to the door. Thus, in the exemplary embodiment, when the knob 60 is rotated in the clockwise direction the door will be pivoted downward to the partially or fully open position. When the knob is rotated in the counterclockwise direction the door will be pivoted upward to the closed position. Other means can be provided to effect the pivoting of the door between the open and closed positions, and vice versa.

As mentioned earlier the dispenser 52 is configured to automatically open the uppermost bag 54B of the stack 54 when the door 56G is pivoted to the partially open state. To that end, the inner surface of the door includes a grasper that is configured to releasably grasp a portion of the front panel 22 of the uppermost bag to pull it away from the rear panel 24 and thereby open the bag's mouth 34. The grasper can take various forms. In the exemplary preferred embodiment of the dispenser 52, the grasper is in the form of a patch 62 having a releasably securable adhesive outer surface 62A. The patch 62 is mounted on a biasing means or member 64, which in turn is mounted on the inner surface of the door, so that the adhesive surface 62A faces the interior 56F. The biasing member 64 is configured to automatically bring the adhesive surface 62A of the patch into engagement with a portion of the front panel 22 of the uppermost bag 54B of the stack, irrespective of how many bags are in the stack. The biasing member can take various forms, e.g., it can be an elastomeric, e.g., rubber or foam, pad whose thickness when uncompressed will be sufficient to bring the adhesive surface onto a portion of the front panel of the stack even if the stack only has one bag left in it. Alternatively the biasing member can be a spring loaded panel, whose spring(s) when in their natural or unbiased state will be sufficient to also bring the adhesive surface onto a portion of the front panel of the stack even if the stack only has one bag left in it. In fact, it is contemplated that the stack of bags itself can be biased by another biasing member (not shown) into engagement with the patch 62 instead of (or in addition to) use of the biasing member 64. In such a case, the other biasing member can be an elastomeric, e.g., rubber or foam, pad whose thickness when uncompressed will be sufficient to bring a stack having only a single bag remaining in it into engagement with the patch 62. Alternatively the other biasing member can be a spring loaded panel, whose spring(s) when in their natural or unbiased state will be sufficient to also bring the stack having only a single bag remaining in it into engagement with the patch 62.

Use of the foregoing system including the dispenser 52 and the stack of bags 54 is as follows. The dispenser 52 is prepared for loading of a stack of bags in it, by rotating the knob 60 in the clockwise direction to pivot the door 56G to at least the partially open position so that the adhesive surface 62A is retracted from the interior 56F of the housing. A stack of bags 54 can then be loaded into the socket of the lid or cover 38, as mentioned above. The lid or cover with the stack is then mounted on the housing, with the door 56G still open, so that the stack 54 is within the hollow interior 56F of the housing and with the lowermost bag 54A of the stack immediately adjacent the inner surface of the rear wall 56B of the housing. The adhesive surface 62A of the patch will not interfere with the disposition of the stack within the interior of the housing since that surface will be retracted, i.e., the door at least partially open. Once the stack is within the interior of the housing, the knob 60 is then be rotated in the counterclockwise direction, to close the door. This action brings the adhesive surface 62A of the pad 62 into engagement with a portion of the panel 22 of the uppermost bag 54B of the stack. The dispenser is now loaded and ready for use.

When it is desired to seal a personal electronic device within a bag, the knob 60 is rotated in the clockwise direction to pivot the door downward. That action opens the mouth of the bag as described above. The personal electronic device can then be introduced into the opened bag and when it is fully located in the bag, the bag with the personal electronic device in it can be removed from the dispenser 52. For example, the knob 60 can be rotated further in the clockwise direction to more fully open the door to thus provide greater access to the interior of the dispenser to facilitate removal of the bag with the personal electronic device therein from the interior of the housing.

The stickiness of the releasably securable adhesive surface 62A is such that the bag can be readily pulled off of the adhesive surface 62A without tearing or otherwise injuring the bag. Moreover, the adhesive forming the surface 62A is such that it is reusable, i.e., it will retain its stickiness to for at least the number of bags in the stack.

Once the bag with the personal electronic device in it is free of the dispenser the bag can be sealed as described above. Alternatively, if the door is opened to its fully open position there will be sufficient access space to enable a user can seal the personal electronic device within the bag while the bag is still within the interior of the housing and then the sealed bag with the personal electronic device therein can be removed from the dispenser. In any case once the bag with the personal electronic device in it has been removed from the dispenser, with the dispenser either in a partially open state or a fully open state (like shown in FIG. 10), the knob 60 can be rotated in the counterclockwise direction to reclose the door and to bring the adhesive surface 62A of the pad 62 into releasable secured engagement with a portion of the panel 22 of now uppermost bag in the stack, thereby closing the housing to keep the stack of bags sanitary, while also readying the dispenser for subsequent use.

The adhesive patch 62 is preferably configured so that it can be mounted on the biasing member 64 so that it can readily be replaced when necessary. The patch 62 is best seen in FIG. 10 and is a thin generally planar member formed of any suitable material and having an outer surface, the central portion 62A of which is a releasably securable adhesive, like that of an adhesive bandage or a POST-IT® note. The adhesive surface 62A is located in the center of the patch 62 and is surrounded by a non-adhesive area 62B, to facilitate the removal of the bag from the adhesive surface when the bag with the personal electronic device therein is removed from the dispenser 52. The rear surface of the patch 62 includes any type of a releasably securable adhesive to releasably mount the patch on the biasing member 64. A releasably securable liner sheet 66 (shown by the broken lines in FIG. 10) is located over the rear surface of the patch to protect the adhesive thereon until the patch is ready for mounting on the biasing member. A similar liner sheet (not shown) can be releasably mounted on the front adhesive surface 62A to protect that surface until the patch 62 is ready for mounting on the biasing member. Ideally, the patch 62 would be removed and replaced whenever inserting a new stack of bags into the dispenser.

It must be pointed out at this juncture that that the bag 20 as described above is merely exemplary of one bag for holding a cellular telephone, tablet computer, laptop computer, or other personal electronic device. Thus, the bag 20 can be of different size or shapes for other cellular telephones or other types of personal electronic devices, e.g., tablet computers, laptop computers, pagers, etc., that could be brought into hospital rooms or any room where containing a sick person or a person with a compromised immune system to prevent infection of that patient. Moreover, instead of having the panels 22 and 24 sealed along their edges 22B and 24B by the seal line 26, those panels may be formed of a single sheet of flexible material that is folded, so that the fold line forms the coincident sealed edges 22B/24B. Furthermore, the material making up the bag need not be polypropylene or low density polyethylene, but can be any suitable flexible material which is preferably transparent and sufficiently thin and/or flexible to permit full use of the electronic device through the panels of the bag, while still providing effective isolation for any pathogens on the device held in the bag's pocket or cavity. Further still, it is contemplated that the material making up one or both the panels be configured to increase in opacity after a certain amount of time to indicate that the user must remove and throw away the bag. Alternatively the material making up one or both of the panels can be configured to change color after a certain amount of time to indicate that the user must remove and throw away the bag. Further still, the flexible material making up on or more of the panels making up the bag 20 can be treated with an anti-microbial solution. Insofar as the dispensers are concerned, various changes can be made to them as well.

Without further elaboration the foregoing will so fully illustrate our invention that others may, by applying current or future knowledge, adopt the same for use under various conditions of service.

I claim:

1. A disposable bag for accommodating and isolating a cellular telephone, tablet computer, laptop computer, or other personal electronic device, from the ambient atmosphere so that any pathogens thereon are sealed and isolated within said bag, said bag comprising:
a. first panel formed of a flexible material having a first end edge portion, a second panel formed of a flexible material and having a second end edge portion, said flexible material of at least one of said panels being configured to enable the operation of a touch screen of the cellular telephone, tablet computer, laptop computer, or other personal electronic device through said panel, said first and second panels being secured together along portions thereof other than said first and second end edge portions to form an internal cavity having a mouth defined by said first and second end edge portions, said mouth being open to enable the cellular telephone, tablet computer or laptop computer to be introduced therethrough into said internal cavity, said second end edge portion extending beyond said first edge portion to form a flap;
b. a first securement region on said first panel and located adjacent said first end edge portion;
c. a second securement region on said second panel and located adjacent said second end edge portion;
d. a first weakened frangible line extending along at least a portion of said first panel;
e. a second weakened frangible line extending along at least a portion of said second panel and coincident with said first weakened frangible line;
f. an adhesive located on one of said securement regions; and
g. a removable liner releasably secured to said adhesive, said removable liner being configured to be removed from said adhesive to expose said adhesive, said flap being configured to be folded over said first securement region after said removable liner has been removed from said adhesive, whereupon said adhesive fixedly secures said second securement region to said first securement region, thereby closing said mouth and sealing said cellular telephone, tablet computer or laptop computer within said internal cavity.

2. The disposable bag of claim 1, wherein said first and second panels each include a side edge and with said first and second panels being fixedly secured together along said side edge, said first and second weakened frangible lines extending from said side edge.

3. The disposable bag of claim 2, wherein said side edge of each of said first and second panels at the location of said weakened frangible lines includes a notch cut therein, so that the bag can be grasped and torn along said weakened frangible lines starting at said notch.

4. The disposable bag of claim 1, wherein said flexible material of at least one of said panels is transparent.

5. The disposable bag of claim 1, wherein said flexible material of said first and second panels comprises polypropylene or low density polyethylene.

6. The system of claim 1, wherein at least one of said panels is configured to change appearance after a certain amount of time to indicate that the bag should be discarded.

7. The system of claim 1, wherein at least one of said panels includes an antimicrobial agent.

8. A system for dispensing disposable bags, each of said bags being configured for accommodating and isolating a cellular telephone, tablet computer, laptop computer, or other personal electronic device from the ambient atmosphere so that any pathogens thereon are sealed and isolated within said bag, said system comprising:
a. a dispenser comprising a housing configured for receipt of a plurality of disposable bags, said housing being configured to enable the dispensing of said disposable bags one at a time; and
b. a plurality of disposable bags, each of said bags comprising:
(1) a first panel formed of a flexible material and having a first end edge portion, a second panel formed of a flexible material and having a second end edge portion, said flexible material of at least one of said panels being configured to enable the operation of a touch screen of the cellular telephone, tablet computer, laptop computer, or other personal electronic device through said panel, said first and second panels being secured together along portions thereof other than said first and second end edge portions to form an internal cavity having a mouth defined by said first and second end edge portions, said mouth being open to enable the cellular telephone, tablet computer or laptop computer to be introduced therethrough into said internal cavity, said second end edge portion extending beyond said first edge portion to form a flap;
(2) a first securement region on said first panel and located adjacent said first end edge portion;
(3) a second securement region on said second panel and located adjacent said second end edge portion;
(4) a first weakened frangible line extending along at least a portion of said first panel;
(5) a second weakened frangible line extending along at least a portion of said second panel and coincident with said first weakened frangible line;
(6) an adhesive located on one of said securement regions; and
(7) a removable liner releasably secured to said adhesive, said removable liner being configured to be removed from said adhesive to expose said adhesive, said flap being configured to be folded over said first securement region after said removable liner has been removed from said adhesive, whereupon said adhesive fixedly secures said second securement region to said first securement region, thereby closing said mouth and sealing said cellular telephone, tablet computer or laptop computer within said internal cavity.

9. The system of claim 8, wherein said first and second panels each include a side edge and with said first and second panels being fixedly secured together along said side edge, said first and second weakened frangible lines extending from said side edge.

10. The system of claim 9, wherein said side edge of each of said first and second panels at the location of said weakened frangible lines includes a notch cut therein, so that the bag can be grasped and torn along said weakened frangible lines starting at said notch.

11. The system of claim 8, wherein said flexible material of at least one of said panels is transparent.

12. The system of claim 8, wherein said flexible material of said first and second panels comprises polypropylene or low density polyethylene.

13. The system of claim 8, wherein at least one of said panels is configured to change appearance after a certain amount of time to indicate that the bag should be discarded.

14. The system of claim 8, wherein at least one of said panels includes an antimicrobial agent.

15. The system of claim 8, wherein each of said bags is openable and wherein said dispenser is configured to open one of said bags at a time, to enable a cellular telephone, tablet computer, laptop computer, or other personal electronic device to be inserted therein without a person having to touch said bag to open it.

16. The system of claim 15, wherein said plurality of bags is in the form of a stack of bags, having an uppermost bag, and wherein said dispenser includes a door moveable between and open and closed position, and vice versa, said door when in said closed position being configured to releasably grasp a portion of said uppermost bag, whereupon when said door is moved to said open position said bag is opened to enable the cellular telephone, tablet computer, laptop computer, or other personal electronic device to be inserted therein.

17. The system of claim 16, wherein said door includes an adhesive surface configured to releasably grasp said portion of said uppermost bag.

18. The system of claim 17, wherein said system additionally comprises a biasing member to ensure that said adhesive surface releasably grasps said portion of said uppermost bag irrespective of the number of bags in said stack.

19. A method of protecting a person from pathogens that may be located on a cellular telephone, tablet computer, laptop computer or other electronic device, said method comprising:
a. providing a disposable bag having a first panel formed of a flexible material having a first end edge portion, a second panel formed of a flexible material and having a second end edge portion, said flexible material of at least one of said panels being configured to enable the operation of a touch screen of the cellular telephone, tablet computer, laptop computer, or other personal electronic device through said panel, said first and second panels being secured together along portions thereof other than said first and second end edge portions to form an internal cavity having a mouth defined by said first and second end edge portions, said second end edge portion extending beyond said first edge portion to form a flap, at least one of said panels including a weakened frangible line, said first panel having a first securement region located adjacent said first end edge portion, said second panel having a second securement region located on said flap adjacent said second end portion, an adhesive located on one of said securement regions, and a removable liner releasably secured to said adhesive;
b. introducing the cellular telephone, tablet computer, laptop computer or other electronic device through said mouth into said internal cavity;
c. removing said liner from said adhesive to expose said adhesive;
d. folding said flap over said first panel to fixedly secure said first securement region to said second securement region by said adhesive to thereby isolate the cellular telephone, tablet computer, laptop computer or other electronic device within the cavity, whereupon the cellular telephone, tablet computer, laptop computer or other electronic device can be operated while within said bag and without exposing the person to any pathogens on the cellular telephone, tablet computer, laptop computer or other electronic device.

20. The method of claim 19, additionally comprising tearing bag along said weakened frangible line to open said bag, whereupon the cellular telephone, tablet computer, laptop computer or other electronic device can be removed therefrom and the bag discarded.

21. The method of claim 19, wherein said disposable bag is located within a sanitary dispenser located adjacent or in a room where the person is located, and wherein said sanitary dispenser comprises housing is configured to hold a plurality of said bags in a sanitary state and to enable an individual bag to be removed from the dispenser for use.
